(19) United States
(12) Patent Application Publication
(10) Pub. No.: US 2010/0143432 A1
(43) Pub. Date: Jun. 10, 2010

(54) Method for Protecting Wood Stacks from Infestation by Wood Pests

(75) Inventors: Thomas Zuehlke, Solingen (DE); Hassan Elamri, Mannheim (DE); Michael Habermann, Bernshausen (DE); Rainer Hurling, Northeim (DE); Uwe Schmidt, Hedemuenden (DE); Holger Kuprat, Seesen (DE); Henning Geske, Bad Lauterberg (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/601,346

(22) PCT Filed: May 21, 2008
(86) PCT No.: PCT/EP2008/056247

§ 371 Date: Feb. 19, 2010

(30) Foreign Application Priority Data
May 22, 2007 (EP) 07108626.8

(51) Int. Cl. A01N 25/34; A01M 1/20

(52) U.S. Cl. 424/411; 43/132.1

(57) ABSTRACT

A method of protecting log dumps from attack by harmful organisms during storage, where the log dumps are largely covered with a sheet-like material (M), where this sheet-like material (M) has, as the result of impregnation with an insecticidal active ingredient, a protective activity against harmful organisms, which method can be employed in a simple fashion over large areas, in remote locations.

The present invention relates to a method of protecting log dumps in which timber or timber-derived materials are protected from attack by timber pests, in particular beetle species which breed in the bark and in the wood. The invention also relates to a device for protecting log dumps from attack by timber pests. The timber pests in question are, for example, longhorn beetles (Cerambycidae), flat-head beetles (Buprestidae), weevils (Circulionidae), bark beetles (Scolytidae), wood wasps (Siricidae), sawflies, pseudocaterpillars and biting and sucking insects.

Against the background of an increasingly occurring climate change, large parts of Europe, but also other places, are regularly flattened by strong winds which result in widespread windthrow in forests. This wind-fallen wood can frequently not be processed immediately but must be protected on-site for weeks or months against timber pests. The term log dumps is to be understood in the broad sense hereinbelow and comprises not only a stacked arrangement of short wood sections, but also timber stacks (for example with log lengths of more than 2 m) and other collection of logs which are found in forests.

At the same time, it can found that the bark-beetle density in Europe is increasing and that other timber pests are becoming increasingly common. The existing protection systems for timber, in particular for timber which is not to be processed within a short time, are hitherto insufficient.

A variety of methods for preserving timber and timber-derived materials have been known for many years. Thus, for example, DE-A 24 38 334 describes the preservation of logs by treating the wood with insecticidal or fungicidal active ingredients in an oil-comprising solvent. The disadvantage of such treatment methods is in particular that applying the active ingredients is laborious and that large amounts of environmentally hazardous substances are employed. Such methods can therefore not be employed repeatedly in the same location.

It is in particular the following methods which are currently available in practical forestry for protecting timber-derived products:
a) dry storage which, however, is only possible for a limited period, frequently entails a complicated treatment of the logs with plant protectants and an increased risk of devaluing the material,
b) wet storage, which is technically complicated and can only be applied to healthy timber,
c) film storage, where the protection of valuable timbers is possible to a limited extent by increasing the carbon dioxide concentration under a tarpaulin,
d) various spray methods in which the logs are treated preventively or else curatively with chemical plant protectants which, however, leads to considerable local environmental hazard as well as a hazard to forest operators.

It is an object of the present invention to provide a method of protecting log dumps in which an inexpensive environmentally friendly preservation of timber which can also be applied over a large area and in a simple manner, even on a large scale, is possible.

The object is achieved by a method of protecting log dumps from attack by harmful organisms during storage, where the log dumps are largely covered with a sheet-like material (M), this sheet-like material (M) having a protective activity against harmful organisms. In this context, the term largely covered means that the timber stack is surrounded almost completely by the sheet-like material (with the exception of the area on which it rests), so that for example flying insects which approach do not land directly on the timber. Log dumps are understood as meaning timber stacks of various shapes and sizes.

The invention also relates to a method in which the sheet-like material (M) employed is a natural or synthetic textile material, a plastic film or a cellulose-comprising mesh.

The sheet-like material (M) employed is frequently a mesh. The sheet-like material (M), for example in the form of a mesh, is pretreated with at least one insecticidal active ingredient (I) or else is treated with active ingredient on-site.

In a particular embodiment of the invention, the sheet-like material (M) is pretreated with at least one insecticidal active ingredient (I), and a pheromone is additionally applied as further active ingredient. Both active ingredients may have been applied beforehand, may be applied on-site or may be applied in part beforehand and in part on-site.

In a further embodiment of the invention, the sheet-like material (M) is applied to the log dumps together with a support material (S), for example a stabilizing plastic mesh. Here, the sheet-like material (M) can be applied to the log dumps together with a polymeric support material (S) which polymeric support material increases the mechanical stability of the sheet-like material (M).

The sheet-like material (M) may have been pretreated or may be treated on-site with a composition which comprises at least one pesticidal component (P) and at least one polymeric binder (B). The composition applied to the sheet-like material (M) preferably comprises 0.1 to 95% by weight of at least one pesticide (P) and 5 to 99% by weight of at least one binder (B).

In particular, the composition applied to the sheet-like material (M) comprises 0.1 to 40% by weight of at least one pesticide (P) and 5 to 95% by weight of at least one binder (B).

The pesticide component (P) employed is frequently an insecticide selected from the group of the pyrethroids, carbamate compounds or organophosphorus compounds.

The binder (B) employed is frequently a polymer selected from the group consisting of polyacrylates, polymethacrylates, polyacrylonitriles, polystyrenes, polymethylstyrenes, polybutadienes, polyvinyl acetates, polyvinyl alcohols and copolymers obtained by polymerization of monomers comprising at least two ethylene groups.

In a particular embodiment of the invention, an insect-attracting device is employed in addition to the sheet-like material (M), which insect-attracting device can be fastened together with the sheet-like material (M). This insect-attracting device may be for example a pheromone trap.

The invention also relates to the use of a sheet-like material (M) which has a protective activity against harmful organisms for preventing the attack of log dumps by harmful organisms.

The invention also relates to a device for protecting log dumps from harmful organisms, which device comprises a sheet-like material (M) which has a protective activity against harmful organisms and which essentially covers the surface of the log dumps.

In one embodiment of the method according to the invention, the sheet-like material (M) employed is a natural or synthetic textile material (for example cotton or polyester tissue), a plastic film (for example made of polypropylene, polyethylene, polystyrene or cellulose), or a cellulose-comprising mesh.

The sheet-like material (M) employed may be a mesh, which may be of varying size and nature. Depending on the intended use, it also possible to vary the mesh size of the mesh, for example from 0.5 mm to 25 mm, preferably from 1 mm to 20 mm.

The sheet-like material (M) is preferably pretreated with at least one pesticidal component (P), in particular at least one insecticidal active ingredient (I). However, it may also be treated with the active ingredient on-site, that is to say for example in the forest. The pesticidal component (P) which is employed preferably takes the form of insecticides (I), if appropriate also in combination with further pesticidal components such as, for example, fungicides (F).

Insecticides which are suitable are, in particular, the following active ingredients, which are already known (see “The Pesticide Manual”, Edition 2003, E. C. Tanlin):
1) acetylcholine esterase (AChE) inhibitors
   Carbamates,
   for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, and triazamate.
   Organophosphates,
   for example acephate, azamethiphos, azinphos(-methyl, -ethyl), bromophos-ethyl, bromfenvinfos, (-methyl), butathiofos, cadusafos, carbophenothion, chlorethoxyfos, chlorfenvinphos, chlormephos, chlorpyrifos(-methyl/-ethyl), coumaphos, cyanofenphos, cyanophos, chlorfenvinphos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemetonmethyl, parathion(-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon and vamidothion.
2) Sodium channel modulators/voltage-dependent sodium channel blockers
   pyrethroids,
   for example acrinathrin, allethrin (d-cis-trans, d-trans)ₛ beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin, (IR isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (IR trans isomer), prallethrin, profluthrin, protrifenbute, pyresmethrin, resmethrin, RU 15525, silafluofen, tau-fluvalinate, tefluthrin, terallethrin, tetramethrin (IR isomer), tralomethrin, transfluthrin, ZXI 8901 and pyrethrins (pyrethrum).
   DDT
   oxadiazine
   for example indoxacarb.
3) Acetylcholine receptor agonists/antagonists
   chloronicotinyls,
   for example acetamiprid, clothianidin, dinotefuran, imidacloprid, nitenpyram, nithiazine, thiacloprid, thiamethoxam, nicotine, bensultap and cartap.
4) Acetylcholine receptor modulators
   spinosyns, for example spinosad.
5) GABA-controlled chloride channel antagonists organochlorines, for example camphechlor, chlordane, endosulfan, gamma-HCH, HCH, heptachlor, lindane and methoxychlor, fiprols,
   for example acetoprole, ethiprole, fipronil, pyrafluprole, pyriprole and vaniliprole.
6) Chloride channel activators
   mectins,
   for example avermectin, emamectin, emamectin-benzoate, ivermectin and milbemycin.
7) Juvenile hormone mimetics,
   for example diofenolan, epofenonane, fenoxycarb, hydroprene, kinoprene, methoprene, pyriproxifen and triprene.

It is preferred to employ those insecticides which are active against timber pests, in particular against beetle species which breed in the bark and in the wood. These include for example active ingredients such as the pyrethroids (for example alpha-cypermethrin). Fipronil, amidrazone and chlorfenapyr are also suitable.

A further embodiment of the invention relates to a method in which the sheet-like material (M) is pretreated with at least one insecticidal active ingredient (I) and to which furthermore a pheromone is applied as further active ingredient. In this context, the pheromone can be, or have been, applied to the sheet-like material (M), or else it may be applied directly to the log dumps.

In a further embodiment, the sheet-like material (M) may also be applied to the log dump together with a support material (S). Here, it is possible for example to apply an impregnated textile material together with a polymeric support mesh to the log dump. The two components can, for example, be brought on-site together as a roll and then rolled out over the log dumps on-site.

The sheet-like material (M) is frequently employed together with a polymeric support material (S) which increases the mechanical stability of the sheet-like material (M). In this manner, the chances are increased of re-employing the protective device even after prolonged use, for example after several months of being exposed to the elements.

The sheet-like material (M) is preferably either pretreated or is treated on-site with a composition comprising at least one pesticidal component (P) and at least one polymeric binder (B). One purpose of employing the binder is to improve the long-term binding of the active ingredient to the sheet-like material. Also, it is intended to allow as uniform a release of the active ingredient as possible.

An example of such a binder (B) which can be employed is a polymer, for example from the group of the polyacrylates, polymethacrylates, polyacrylonitriles, polystyrenes, polymethylstyrenes, polybutadienes, polyvinyl acetates, polyvinyl alcohols and the copolymers obtained by polymerization of monomers comprising at least two ethylene groups.

The selection of the pesticidal component (P) and of the binder (B) should be matched to one another and to the intended purpose, as should the amounts employed.

In a preferred embodiment, the composition applied to the sheet-like material (M) comprises 0.1 to 95% by weight, in particular 0.1 to 90% by weight, preferably 0.1 to 40% by weight, of at least one pesticide (P). It furthermore comprises 0.1 to 99% by weight, in particular 0.5 to 90% by weight, preferably 0.5 to 40% by weight, of at least one binder (B). A particular embodiment of the composition comprises 0.1 to 1% by weight of insecticide (for example alpha-cypermethrin) and 0.5 to 1.5% by weight of binder.

In the method according to the invention, an insecticide (I) selected from the group consisting of the pyrethroids, the carbamate compounds or the organophosphorus compounds is preferably employed as the pesticide component (P).

These insecticides can preferably be combined with a binder (B) selected from the group of the polyacrylates, polymethacrylates, polyacrylonitriles, polystyrenes, polymethylstyrenes, polybutadienes, polyvinyl acetates, polyvinyl alcohols and copolymers obtained by polymerization of monomers comprising at least two ethylene groups.

In the above-described method, it is possible to employ, in addition to the sheet-like material (M), an insect-attracting device (for example an insect trap, in particular a pheromone-comprising component), which can be fastened together with the sheet-like material (M).

The invention also relates to the use of a sheet-like material (M) which has a protective activity against harmful organisms for preventing the attack by harmful organisms of timber and, in particular, log dumps. Attack by harmful organisms which is preferably controlled is caused for example by the Norway spruce engraver (Ips typographus), the six-dentated engraver beetle (Pytyogenes chalcographus) or the striped ambrosia beetle (for example Trypodendron lineatum).

The present invention also relates to a device for protecting log dumps from harmful organisms, which device comprises a sheet-like material (M) which has a protective activity against harmful organisms and which essentially covers the surface of the log dumps.

The invention also relates to a device for protecting log dumps from harmful organisms, which device comprises a sheet-like material (M) as described hereinabove. This device may comprise further elements, for example a mobile frame, fastening elements which allow the (preferably reversible) fixing of the sheet-like material (M) to the log dumps, or hooks and eyes which simplify the mechanical detaching of the protective device.

Insect-repellent components which may additionally also be employed in the method and/or device according to the invention are for example the following active ingredients:

N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl)acetic acid lactone, 2-ethyl-1,3-hexanediol, indalone, methylneodecaneamide (MNDA), {+/−)-3-allyl-2-methyl-4-oxocyclopent-2-(+)-enyl (+)-trans-chrysanthemate (esbiothrin), limonene, eugenol, (+)eucamalol (1), (−)-1-epi-eucamalol, extracts of Eucalyptus maculata, Vitex rotundifolia, Cymbopogan martinii, Cymbopogan citratus, Cymopogan nartdus, ethyl butylacetylaminopropionate or icaridin (1-piperidinecarboxylic acid 2-(2-hydroxyethyl) 1-methylpropyl ester).

These insect-repellant substances which have already been mentioned and the fungicides which are listed hereinbelow may for example already be applied beforehand to the sheet-like material, for example by spraying textile material. However, it is also possible only to apply these components on-site.

Examples which may be used as additional pesticide in the method according to the invention are the following fungicides, which are already known:
1) azoles: bitertanol, bromoconazole, cyproconazole, difenoconazole, dinitroconazole, epoxiconazole, fenbuconazole, fluquiconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole, triticonazole;
2) strobilurins: azoxystrobin, dimoxystrobin, fluoxastrobin, kresoximmethyl, metominostrobin, orysastrobin, picoxystrobin, pyraclostrobin and trifloxystrobin; acylalanines such as benalaxyl, metalaxyl, mefenoxam, ofurace, oxadixyl; amine derivatives such as aldimorph, dodine, dodemorph, fenpropimorph, fenpropidin, guazatine, iminoctadine, sprioxamine, tridemorph;
3) anilinopyrimidines: pyrimethanil, mepanipyrim, cyprodinil;

dicarboximides such as iprodion, myclozolin, procymidon, vinclozolin; cinnamic amides and derivatives such as dimethomorph, flumetover, flumorph; antibiotics such as cycloheximide, griseofulvin, kasugamycin, natamycin, polyoxin, streptomycine;
4) dithiocarbamates: ferbam, nabam, maneb, mancozeb, metam, metiram, propineb, polycarbamate, thiram, ziram, zineb;
5) heterocyclic substances: anilazine, benomyl, boscalid, carbendazim, carboxin, oxycarboxin, cyazofamid, dazomet, dithianon, famoxadon, fenamidon, fenarimol, fuberidazole, flutolanil, flurametpyr, isoprothiolane, mepronil, nuarimol, picobenzamid, probenazole, proquinazid, pyrifenox, pyroquilon, quinoxyfen, silthiofam, thiabendazole, thifluzamid, thiophanate-methyl, tiadinil, tricyclazole, triforine;
6) nitrophenyl derivatives: binapacryl, dinocap, dinobuton, nitrophthalisopropyl;
7) phenylpyrroles: fenpiclonil, fludioxonil;
8) sulfonic acid derivatives: captafol, captan, dichlofluanid, folpet, tolylfluanid;

9) other fungicides: acibenzolar-S-methyl, benthiavalicarb, carpropamid, chlorothalonil, cyflufenamid, cymoxanil, dazomet, diclomezin, diclocymet, diclofluanid, diethofencarb, edifenphos, ethaboxam, fenhexamid, fentin-acetate, fenoxanil, ferimzone, fluazinam, fosetyl, fosetyl-aluminum, phosphoric acid, iprovalicarb, hexachlorobenzene, metrafenon, pencycuron, propamocarb, phthalid, toloclofos-methyl, quintozene, zoxamid.

The invention is illustrated in greater detail by the examples which follow.

### EXAMPLE 1

The protective device according to the invention consists of a support mesh (for example a woven mesh made of a polymeric material (such as polypropylene), 5.0 m wide and 25.0 m long; on a roll) and of a specific textile, for example made of cotton, active ingredient support attached thereto in such a way as to cover the entire area, which is impregnated in a lasting fashion with a suitable insecticide. The insecticidal active ingredient employed is for example alpha-cypermethrin (pyrethroid manufactured by: BASF AG, Ludwigshafen) at a concentration of 20 mg per square meter of the cotton support. The active ingredient can be applied for example as an aqueous solution of the active ingredient together with a binder (for example a polyacrylate). The fixing to the cotton support should be resistant to washing or rainfast.

Depending on the location of its use, the climatic conditions, the material used, the thickness of the mesh, the type of active ingredient and the desired service life (in weeks) of the device, the insecticidal active ingredient may be employed at a concentration of from 1 to 150 mg, preferably 1 to 100 mg, per square meter of the support.

To ensure a long-term activity, the textile active ingredient support is connected firmly and durably with the supporting mesh. As an alternative, however, the textile active ingredient support (for example designed as a mesh or film) may also be used directly (i.e. without support mesh).

To transport and employ the system according to the invention, the textile active ingredient supports which have already been preimpregnated are moved using a support system so that contamination of the user can largely be avoided during transport. The textile active ingredient supports can be unwound over the log dumps, and, after the residence time taken up again, with customary large machinery (for example MB track) and a suitable extension arm (for example beam, bar or roll hanger). A reversible fastening of the textile active ingredient supports to the log dumps is possible in reversible form, for example via metal tackers.

### EXAMPLE 2

In a specific embodiment of the invention, the textile active ingredient supports may also be used repeatedly. For example, the textile active ingredient support may, after several months, be removed from a log dump, rolled up and applied to a different log dump. The duration of use depends on the intended purpose, the use conditions (for example climate), the type of wood and the active ingredients employed.

In general, the duration of application to the log dump or stack is from once, for a few days (for example a week), up to repeatedly (for example three times) for a year.

Mounting of the sheet-like material (M) is performed either by hand or with the aid of machines, for example by applying the sheet-like material, which is transported on rolls, by means of an unwinding system (which may, for example, be tractor-mounted) onto the dumps or stacks and then, if appropriate, fixing by means of tackers.

Likewise, removing the sheet-like material (M) is performed either by hand or by means of machinery, which again depends on whether the sheet-like material is to be reused or not. For example, the sheet-like material can be wound onto the rolls by means of a winding system (which for example may be mounted to a grappler) and then be taken away and, if appropriate, reused after processing (by reimpregnation).

### EXAMPLE 3

However, the textile active ingredient supports may also be such that they are thermally disposed of in an environmentally friendly manner as part of the utilization for energy purposes of residual timber which has been protected over a limited period of time using this system, for example by combustion in order to generate energy. To this end, a sheet-like material is used which consists of cotton impregnated with alpha-cypermethrin.

### EXAMPLE 4

In a further embodiment of the invention, the textile active ingredient support, which is made of polyester, is first applied to the log dump on-site and subsequently sprayed with a solution or emulsion of the insecticide (for example alpha-cypermethrin, manufacturer: BASF AG).

In this context, it is also possible to additionally apply to the textile active ingredient support or to the supporting meshes connected thereto the active ingredient Pheroprax (manufacturer: BASF AG) as pheromone which attracts the harmful insects (for example the Norway spruce engraver, Ips typographus). The insects will then be attracted from all around the log dump, land on the sheet-like material and are destroyed as a result of the contact with the active ingredient support.

Good results can also be achieved by combining applied insecticides with Chalcoprax (manufacturer: BASF AG), which attracts the harmful insects (for example the six-dentated engraver beetle, Pytyogenes chalcographus). Convincing results are also obtained with further commercially available pheromones which have been applied to a support in combination with a pyrethroid, since it is not only the log dumps themselves which are protected from attack, but also the live trees surrounding it. A possibility is for example the use in tree nurseries and “forest camps”, where small nursery plants are particularly endangered.

1-14. (canceled)

15. A method of protecting log dumps from attack by harmful organisms during storage, comprising largely covering the log dumps with a sheet-like material (M), wherein the sheet-like material (M) has a protective activity against harmful organisms, and wherein the sheet-like material (M) is a natural or synthetic textile material, a plastic film or a cellulose-comprising mesh.

16. The method according to claim 15, wherein the sheet-like material (M) is a mesh.

17. The method according to claim 15, wherein the sheet-like material (M) is pretreated with at least one insecticidal active ingredient (I).

18. The method according to claim 15, wherein the sheet-like material (M) is pretreated with at least one insecticidal active ingredient (I), and a pheromone is additionally applied as further active ingredient.

19. The method according to claim 15, wherein the sheet-like material (M) is applied to the log dump together with a support material (S).

20. The method according to claim 15, wherein the sheet-like material (M) is applied to the log dump together with a polymeric support material (S), which polymeric support material increases the mechanical stability of the sheet-like material (M).

21. The method according to claim 15, wherein the sheet-like material (M) is pretreated or is treated on-site with a composition which comprises at least one pesticidal component (P) and at least one polymeric binder (B).

22. The method according to claim 15, wherein the sheet-like material (M) is pretreated or is treated on-site with a composition which comprises at least one pesticidal component (P) and at least one polymeric binder (B), and wherein the composition applied to the sheet-like material (M) comprises 0.1 to 95% by weight of at least one pesticide (P) and 0.1 to 99% by weight of at least one binder (B).

23. The method according to claim 15, wherein the sheet-like material (M) is pretreated or is treated on-site with a composition which comprises at least one pesticidal component (P) and at least one polymeric binder (B), and wherein the composition applied to the sheet-like material (M) comprises 0.1 to 40% by weight of at least one pesticide (P) and 0.5 to 90% by weight of at least one binder (B).

24. The method according to claim 15, wherein the sheet-like material (M) is pretreated or is treated on-site with a composition which comprises at least one pesticidal component (P) and at least one polymeric binder (B), and wherein the pesticide component (P) employed is an insecticide selected from the group of the pyrethroids, carbamate compounds or organophosphorus compounds.

25. The method according to claim 15, wherein the sheet-like material (M) is pretreated or is treated on-site with a composition which comprises at least one pesticidal component (P) and at least one polymeric binder (B), and wherein the binder (B) employed is a polymer selected from the group consisting of polyacrylates, polymethacrylates, polyacrylonitriles, polystyrenes, polymethylstyrenes, polybutadienes, polyvinyl acetates, polyvinyl alcohols and copolymers obtained by polymerization of monomers comprising at least two ethylene groups.

26. The method according to claim 15, wherein an insect-attracting device is employed in addition to the sheet-like material (M), which insect-attracting device can be fastened together with the sheet-like material (M).

27. A device for protecting log dumps from harmful organisms comprising a sheet-like material (M), wherein the sheet-like material (M) has a protective activity against harmful organisms, and wherein the sheet-like material (M) is a natural or synthetic textile material, a plastic film or a cellulose-comprising mesh.
